(19) United States
(12) Patent Application Publication
(10) Pub. No.: US 2011/0286564 A1
(43) Pub. Date: Nov. 24, 2011

(54) ACCELERATOR DRIVEN POWER GENERATION

(76) Inventor: ROLLAND P. JOHNSON, Newport News, VA (US)

(21) Appl. No.: 13/111,197

(22) Filed: May 19, 2011

Related U.S. Application Data
(60) Provisional application No. 61/395,934, filed on May 19, 2010.

(51) Int. Cl. G21G 1/00

(52) U.S. Cl. 376/156

(57) ABSTRACT

A redundant, low cost accelerator driven system for power generation or waste treatment. The system generates fission from fertile nuclear materials and includes multiple charged particle sources, nested redundancy of low energy accelerator sections for reliability, and multiple subcritical reactors. Merging and splitting devices based on radiofrequency transverse kickers enable the nested redundancy. A control system provides RF buckets with identifiers, enabling the control of charged particles on an RF bucket basis through the accelerator, for the delivery to a desired subcritical reactor of a desired number of RF buckets of such predetermined characteristics to generate a desired reactor power. Consequently, the power level of each reactor may be controlled independently even though a large part of the high power accelerator system is used to feed multiple reactors simultaneously.

### CROSS-REFERENCE TO RELATED APPLICATION

This application claims the benefit of U.S. Provisional Application No. 61/395,934, filed May 19, 2010, which is hereby incorporated by reference in its entirety.

### STATEMENT REGARDING FEDERALLY SPONSORED RESEARCH

Not applicable.

### BACKGROUND OF THE INVENTION

1. Field of the Invention

The present invention relates generally to the field of subcritical nuclear power generation. More particularly, this invention relates to applications involving subcritical reactors.

2. Background

In the field of nuclear power generation, much of the development focus has been on reactors designed to operate at self sustaining neutron population or a state of criticality. In this approach, the neutron population must be sufficient to sustain fission, which includes overcoming the various neutron losses; given a particular design. This requirement drives reactor design and fuel selection: uranium or plutonium for critical reactors.

However, interest in nuclear reactors that are designed to operate in a state of subcriticality is growing. In particular, it is believed that subcritical reactors may offer environmental benefits from the use of non-uranium fuels, additional applications or uses such as the treatment of radioactive waste, and the inherent safety of a reactor design with a default state of a loss of criticality.

Consideration of the theoretical potential for subcritical reactors developed over the later portion of the last century. In 1976, Robert Wilson proposed the production of energy using the superconducting accelerator at U.S. Dep't of Energy's (DOE) Fermi National Accelerator Laboratory, in the paper titled, “Very Big Accelerators as Energy Producers” FN-298 (1976). This proposal used the machine that became known as the Tevatron to produce high energy protons, which could then be injected into a spallation surface to make neutrons for power generation. A later paper titled “An Energy Amplifier for Cleaner and Inexhaustible Nuclear Energy Production Driven by A Particle Beam Accelerator” in 1993 by F. Carminati, R. Klapisch, J. P. Revol, Ch. Roche, J. A. Rubio, and C. Rubbia further developed this concept. This paper discussed details of a design referred to as an Energy Amplifier or a thorium reactor that could use either an isochronous cyclotron or a linear accelerator (or “linac”) to generate a neutron flux. Thorium was identified as a breeding fuel, and certain benefits over U-235 were reviewed. In “Conceptual Design of a Fast Neutron Operated High Power Energy Amplifier,” CERN/AT/95-44 (29 Sep., 1995), Rubbia et al. explored the use of Energy Amplifiers; one embodiment included a proposed scheme to use three sequential cyclotrons to produce a drive beam. Thus, an Energy Amplifier is a type of subcritical nuclear reactor in which an energetic particle beam is used to stimulate a reaction, which in turn releases enough energy to power the particle accelerator and to leave an energy profit for power generation. The concept has more recently been referred to as an accelerator-driven system or subcritical reactor (ADS, or ADSR). When the beam is stopped power generation stops; thus, the name ‘accelerator driven systems.’

In these schemes, spallation neutrons were produced by a 10 MW beam of protons directed to a high Z target. The fast neutrons (1-10 MeV) interacted with Thorium 232 (fertile nucleus) to convert it to Protactinium, which in turn decayed into Uranium 233 (Fissile nucleus). (Similarly for U 238, one could make fissile Plutonium 239).

Work in Europe (EUROTRANS), Japan (JAERI/JPARC), Korea (PEFP) and in the U.S. on similar ideas have contemplated the generation of beams up to about 10 MW with rapid cycling synchrotrons (RCS), cyclotrons, or fixed field alternating gradient (FFAG) synchrotrons with energies near 1 GeV and beam currents around 10 mA. While progress is expected, these challenging parameters have not yet been achieved.

### Higher-Energy Superconducting Radiofrequency (SRF) Linacs

Since the 1993 study described above, SRF linac technology has become much more mature, with a number of successful projects and proposals. For example, the 6 GeV continuous electron beam accelerator facility (CEBAF) at the DOE's Thomas Jefferson National Accelerator Facility has demonstrated reliable SRF operation with an electron beam, while advances in cavity construction and processing have shown higher gradients and quality factors that offer lower construction and operating costs. The 1 GeV SRF linac at the Spallation Neutron Source (SNS) with the DOE's Oak Ridge National Laboratory (ORNL), while operating in 60 Hz pulsed mode with a 6% duty cycle, is being used to explore many of the issues relevant to reliable operation and control of losses at high beam power. A proton beam power near the MW-level has already been achieved at SNS, thereby demonstrating the feasibility of one of the key technologies required for ADS. In addition, Free Electron Lasers and synchrotron light sources that are based on CW SRF are likewise becoming commonplace.

The Fermi Laboratory Project X SRF linac was originally envisioned as an 8-GeV pulsed proton linear accelerator. It is anticipated that protons could be stored in the Fermilab Recycler storage ring and delivered to experiments requiring 8 GeV protons. Alternatively, protons could be transferred to an injector accelerator or main injector for acceleration to 120 GeV. Another project is the International Linear Collider (ILC). The ILC is a continuation of the TESLA project that also generated the European XFEL project; all three are based on 1300 MHz SRF operating at a relatively low pulse repetition frequency of 5 to 15 Hz. This low repetition rate makes it difficult to achieve high enough beam power at 8 GeV to be useful for many essential ADS studies.

Although contemplated in some of the foregoing, conventional approaches have not provided an accelerator that has the capability to efficiently and reliably drive a subcritical reactor at high power. Common justification for this inability is that accelerators have not been sufficiently reliable, and lacked the necessary power of performance at reasonable costs. In particular, it is commonly considered that each reactor needs its own accelerator to generate the high energy proton beam, which is very costly. Designing for reliability renders such cost even greater. Apart from linear accelerators, which are very expensive, no proton accelerator of sufficient power and energy (>˜10 MW at 1 GeV) has ever been built. Currently, the SNS utilizes a 1.44 MW pulsed H-beam to produce neutrons, with proposed upgrades envisioned to 5 MW.

### SUMMARY OF THE INVENTION

As noted above, recent developments in accelerators and emphasis on green energy technologies are renewing interest in ADS reactors and accelerator transmutation of nuclear waste (ATW). The DOE is shifting away from the single-pass approach to nuclear energy that would require vast amounts of nuclear waste to be stored at repositories for geological periods of time. This leaves only two options to deal with nuclear waste: fast reactors or accelerator-driven sub-critical systems. Fast reactors operate at criticality and are inherently less safe than the ADS reactor approach. An ADS reactor would use an accelerator to produce a copious supply of neutrons to burn abundant fuels like thorium and un-enriched uranium in a power plant. Switching off the accelerator brings the reactor to a halt. Expansion of conventional types of nuclear reactors employing the single pass approach would exhaust conventional sources of U235 in about a century. ADS and fast reactors, on the other hand, convert plentiful actinides such as Thorium 232 and Uranium 238 into fissile materials while at the same time burning existing nuclear waste to produce energy. ADS reactors have been shown to be more efficient at burning nuclear waste than fast reactors. More neutrons can be supplied by increasing the accelerator power as the fuel is used, deeper burns can be made by using ADSR rather than using a fast reactor without fuel reprocessing.

Some recent accelerator developments for scientific application promise to make even more powerful accelerators feasible. As noted above, Fermilab is developing alternative concepts or modifications for Project X, which would use an experimental SRF linear accelerator that could deliver megawatts of beam power to provide beams for continued particle physics research at the intensity and energy frontiers.

It is contemplated that a continuous-wave (CW) SRF linear accelerator may enable the production of proton beam power on the order of 100 MW at up to ten GeV, which is considerably more than current research proposals, at a modest incremental cost relative to the baseline Project-X. Such an embodiment may be used to drive multiple subcritical reactors for commercial power generation. This approach would become increasingly attractive with the development of a national power grid using low-loss transmission lines based on superconductors. The use of an SRF linac for an ADS nuclear power station with multiple subcritical reactors would introduce several benefits. For example, it would produce electrical power in an inherently safe region below criticality, generate no greenhouse gases, produce minimal nuclear waste and no byproducts that are useful to rogue nations or terrorists, while incinerating waste from conventional nuclear reactors, and efficiently using abundant thorium fuel that does not need enrichment.

Disclosed is an apparatus for generating fission from fertile nuclear materials. The apparatus includes a radiofrequency (RF) accelerator for generating a continuous wave beam of charged particles, the accelerator having at least two sources (each with an output), at least one first stage accelerator section having at least two inputs and at least one output, and operably disposed therebetween at least two low energy beam transport (LEBT) systems, at least one high energy beam transport (HEBT) system, at least one radio-frequency quadrupole, and at least one merging device. The first stage accelerator section has a first stage design energy. A main accelerator section is included, which has an input and an output. The main accelerator section has a design energy that is greater than the design energy of the first stage accelerator section.

A source output is applied to each of the inputs of the first stage accelerator section, the first stage accelerator section bunches the charged particles into RF buckets. The at least one output of the first stage accelerator section is directed to the input of the main accelerator section for higher energy acceleration. A splitting device is disposed at the output of the main accelerator section. The splitting device has an input and a plurality of outputs, where the output RF buckets of the main accelerator section are thus applied to the input of the splitting device.

At least two subcritical reactors are positioned at an output of the splitting device so as to receive the RF buckets. Each of the subcritical reactors comprises a fertile material. The reactors receive the RF buckets so as to generate fission within the fertile nuclear material at a desired reactor power.

A control system is provided. The control system includes a master oscillator and a distribution system in operable communication with (i) the sources, (ii) the merging device(s), (iii) the first stage accelerator sections, (iv) the main accelerator section, (v) the splitting device, and (vi) the subcritical reactors. The activated control system assigns each RF bucket an identifier associated with a desired subcritical reactor and predetermined characteristics for such RF bucket. The control system controls the operation of the sources, the merging device(s), the first stage accelerator sections, the main accelerator section, and the splitting devices to produce for delivery to a desired subcritical reactor a desired number of RF buckets of such predetermined characteristics that upon delivery to the desired subcritical reactor they generate the desired reactor power. Such a control system, with at least one main accelerator and appropriate safety features, allows independent control of the desired output power of each reactor, from completely off to full power.

A number of alternative embodiments, optional aspects, or applications may be provided.

In one approach, the at least one merging device and the at least one radio-frequency quadrupole may be disposed between the at least two LEBT systems and the at least one HEBT system. The at least one merging, device may comprise at least two merging devices and at least one of the merging devices may be disposed within one of the at least two LEBT systems. Alternatively, the at least one merging device may be disposed within the at least one HEBT system. In one embodiment, the at least one HEBT systems comprises at least two HEBT systems, the at least two LEBT systems may discharge into the at least two HEBT systems, and the at least two HEBT systems may discharge into the at least one merging device.

The radiofrequency accelerator may further comprise at least one second stage accelerator section comprising at least one input, at least one output, and operably disposed therebetween at least one LEBT system, at least one HEBT system, at least one radio-frequency quadrupole, and wherein the second stage accelerator section has a second stage design energy that is greater than the first stage design energy and less than the main stage design energy. The at least one merging device may be disposed between the at least one HEBT system of the first stage accelerator section and the at least one LEBT system of the second stage accelerator section. In this case, the at least one output of the first stage accelerator section is applied to the input of the main accelerator section via the second stage accelerator section.

In some embodiments, the main accelerator section is a linear accelerator. This section may be a superconducting linear accelerator. In some cases, the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium. Other aspects may include that the splitting device is a transverse radiofrequency beam splitter, that the at least one merging device is a transverse kicking radiofrequency cavity, or that the fertile nuclear material is Th-232.

In one embodiment, the main accelerator section comprises a plurality of RF cavities and a plurality of bending magnets configured for recirculation of particles between the RF cavities. In such an case, the at least two subcritical reactors may further comprise a primary system containing a moderating primary medium, a secondary system containing a secondary medium, a heat transfer system for transferring thermal energy from the primary medium to the secondary medium, and a generating system for generating electric power from thermal energy in the secondary medium.

In one embodiment, the at least two subcritical reactors comprise a first and a second subcritical reactor and the control system further comprises a computer processor and a memory, first operational requirement data for the radiofrequency accelerator associated with the first subcritical reactor stored within the memory, second operational requirement data for the radiofrequency accelerator associated with the second subcritical reactor stored within the memory. A service software may be executable on the processor, the service software in communication with memory, and wherein the service software is adapted to receive input instructions for a desired state of electrical power generation for the first and second subcritical reactors, associate the input instructions with operational requirement data for the radiofrequency accelerator, and to communicate output instructions to the radiofrequency accelerator to produce the desired power level for the first and second subcritical reactors. The service software may associate the input instructions with operational requirement data on an RF bucket basis. In such an embodiment, the at least two subcritical reactors may further comprise a primary system containing a moderating primary medium, a secondary system containing a secondary medium, a heat transfer system for transferring thermal energy from the primary medium to the secondary medium, and a generating system for generating electric power from thermal energy in the secondary medium.

In some embodiments, the at least one merging device is made using one or more transverse kicking radiofrequency cavities, the splitting device is also made using one or more transverse kicking radiofrequency cavities, the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium.

In some cases, the service software may associate the input instructions with operational requirement data on an RF bucket basis; the at least one merging device is a transverse kicking radiofrequency cavity; the splitting device is a transverse radiofrequency beam splitter; the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium. In another embodiment, the service software may associate the input instructions with operational requirement data on an RF bucket basis using the assigned identifier; the at least one merging device is a transverse kicking radiofrequency cavity; the splitting device is a transverse radiofrequency beam splitter; the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium; and the control system is adapted to direct a desired RF bucket to a desired subcritical reactor.

In one embodiment, the approach is an apparatus for generating fission from Th-232, whether from conventional reactors or other sources. This apparatus may comprise a radiofrequency accelerator for generating a continuous wave beam of charged particles. This accelerator may include at least two sources, each having an output, at least one first stage accelerator section comprising at least two inputs, at least one output, and operably disposed therebetween at least two LEBT systems, at least one HEBT system, at least one radio-frequency quadrupole, and at least one merging device, wherein the first stage accelerator section has a first stage design energy and the at least one merging device is a transverse kicking radiofrequency cavity, a main accelerator section with an input and an output, wherein the main accelerator section has a design energy that is greater than the design energy of the first stage accelerator section, and wherein the output of a source is applied to each of the inputs of the first stage accelerator section, which bunches the particles into RF buckets, and the at least one output of the first stage accelerator section is applied to the input of the main accelerator section. The apparatus may include a splitting device having an input and a plurality of outputs, wherein the output of the main accelerator section is applied to the input of the splitting device, and wherein the splitting device is a transverse radiofrequency beam splitter. At least two subcritical reactors comprising a first and a second subcritical reactor may be included, with each subcritical reactor comprising Th-232, and each of the reactors positioned at an output of the splitting device so as to receive RF buckets and to generate fission within the Th-232 at a desired reactor power. These at least two subcritical reactors may further comprise a spallation target having lead-beryllium or uranium. An aspect may be a control system having a master oscillator and a distribution system in operable communication with the sources, the first stage accelerator section, the main accelerator section, the splitting device, and the subcritical reactors. This control system, when activated, may assign each RF bucket an identifier associated with a desired subcritical reactor and predetermined characteristics for such RF bucket, the control system controlling the operation of the sources, the first stage accelerator section, the main accelerator section, and the splitting device, to produce for delivery to a desired subcritical reactor a desired number of RF buckets of such predetermined characteristics that upon delivery to the desired subcritical reactor, generate the desired reactor power. The control system may further comprise a computer processor and a memory, first operational requirement data for the radiofrequency accelerator associated with the first subcritical reactor stored within the memory, second operational requirement data for the radiofrequency accelerator associated with the second subcritical reactor stored within the memory, a service software executable on the processor, the service software in communication with memory. The service software may be adapted to receive input instructions for a desired state of electrical power generation for the first and second subcritical reactors, to associate the input instructions with operational requirement data for the radiofrequency accelerator, and to communicate output instructions to the radiofrequency accelerator to produce the desired power level for the first and second subcritical reactors.

### BRIEF DESCRIPTION OF THE DRAWINGS

FIG. 1 shows neutron production levels from a proton beam.

FIG. 2 shows LINAC sections with independently phased superconducting sections.

FIG. 3 illustrates the beam merger concept.

FIG. 4 shows source coupling with LINAC sections.

FIG. 5 is a detailed view of several sources routed to more than one LINAC section.

FIG. 6 is a detailed view of input to a high energy main accelerator section and split to desired subcritical reactors.

FIG. 7 shows the beam splitter concept.

FIG. 8 is a block diagram of the power generating system and controller system.

### DETAILED DESCRIPTION

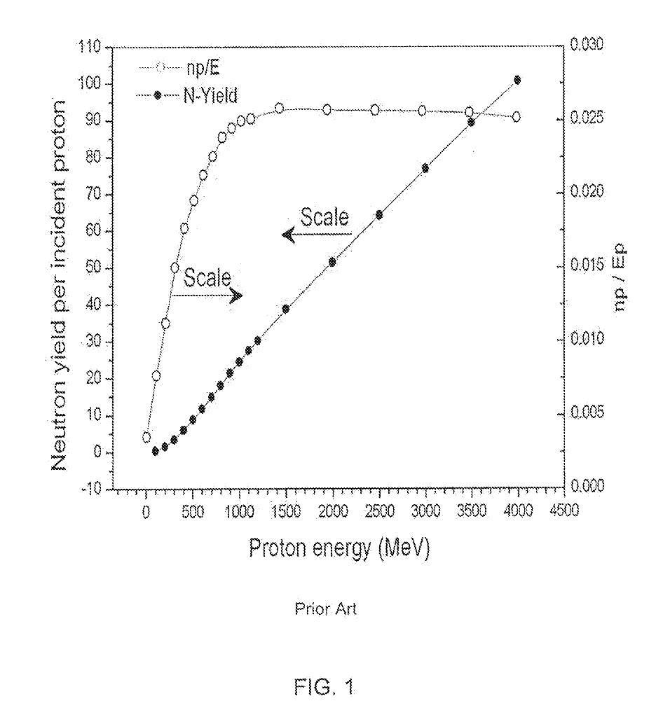

An aspect of the contemplated RF apparatus is an accelerator in continuous-wave (CW) operation. Conventionally, light sources have operated in continuous wave while particle accelerators operated in pulsed mode, such as is required for the International Linear Collider (ILC). For high-energy physics purposes, the CW beam may be accumulated and bunched in, for example, 8-GeV storage rings to then produce beams appropriate to the embodiment, injected either directly onto production targets or to feed a 150-GeV main injector synchrotron. As may be seen in FIG. 1, neutron production (yield) from a proton beam increases linearly with beam power for proton energies above about 1 GeV. It is contemplated that CW operation at 8-GeV, for example, with average beam current of 12.5 mA gives a proton beam power of 100 MW which may thus be appropriate for a commercial multi-GW-scale ADS power plant.

Some may suggest that an ADS design at such an energy level could require a size and complexity of subcritical reactor that would be prohibitive. However, the length of a spallation neutron shower, and therefore the size and complexity of the energy amplifier or other subcritical reactor, is only weakly dependent on beam energy. Accordingly, it is contemplated that with embodiments at about 10 GeV compared to 1 GeV, there might be an increase spallation neutron shower length of about 30%.

Linear accelerators are generally considered to be capable of designs that reliably accelerate particles to higher energy. Although linacs require significant space for location of their facilities, this aspect is common to power generation, and the extended linear configuration enables high current particle beams with low losses and thereby minimize unwanted component radioactivation. Another advantage of higher energy linac sections is that they are suited for modular embodiments, with independently phased SRF cavities, which provide intrinsic redundancy. In addition, linacs are further well adapted for large beam apertures for control of particle losses. The changes that optimize a linac design for CW operation include modifying basic parameters such as the operating cavity gradient, RF power sources, power couplers, and refrigeration loads.

Another embodiment for a higher energy accelerator section may be a recirculating scheme to allow the particles to pass through each RF cavity on more than one pass by using bending magnets in return arcs. A Recirculating Linear Accelerator (RLA) scheme is now used by the CEBAF machine at the Thomas Jefferson National Accelerator Facility to accelerate electrons. Since the magnets used for recirculation in this race-track configuration are less expensive than the RF cavities, the RLA can be a cost-effective alternative to a single linear accelerator. Compared to an electron machine where the arc radius of the RLA is limited by synchrotron radiation, a proton RLA can have higher magnetic fields with smaller radius bending magnet arcs and be more compact than the CEBAF machine.

As noted above, it would be desirable to use a high energy main accelerator section to supply several subcritical reactors; disclosed below is an approach for parallel arrangement of such subcritical reactors. Thus, another aspect of the present approach is to enable the higher-power, higher-energy accelerator to drive several subcritical reactors simultaneously, contrasted to conventional approaches having one accelerator per reactor. This approach improves reliability, efficiency, and lowers cost. Preferably, not only will the intrinsically redundant higher energy accelerator drive multiple subcritical reactors, but embodiments may also include redundancy in lower energy sections, also as disclosed below. This is to distinguish from systems in which an alternative or standby source, or low energy, first stage linac, for example, may be off-line while an alternative is on-line, such that system operation must be interrupted in order to bring the off-line component on-line.

It is very desirable for ADS power generation that the accelerator be extremely reliable. Although steady power output is desirable, there is a greater concern that reactor components might be, damaged by sudden changes in power level. Accordingly, for these reasons, reliability preferably governs design, component selection, redundancy, etc. Several aspects of the present approach involve improved reliability over conventional approaches.

Although this approach requires innovation in control and configuration, some aspects have been demonstrated in accelerator laboratories. Nevertheless, no conventional approach has efficiently scaled employment of the Energy Amplifier with accelerator technology for reliable power generation.

### Elements of Reliability

Thus, the present approach is directed to overcoming the difficulty in the efficient and reliable driving of subcritical reactors by use of high-energy accelerators based on RF cavities, but also providing sufficient power and beam distribution to drive several subcritical reactors in parallel.

The conventional arrangement of accelerator sections in simple series means that the operability of each section is required for the operability of the whole. Some components, such as klystrons, may be replaced during operation of the affected linac section. However, other components, such as SRF cavities, may require shutting down the entire accelerator.

Elements of reliability in the present approach include, without limitation: (i) design optimization of the accelerator for reliability; (ii) nesting or parallel tiers of a plurality of proton sources; (iii) nesting or parallel tiers of a plurality of earlier stage or lower energy linear accelerator sections that may feed into a single, higher energy accelerator section; (iv) nesting or parallel tiers of a plurality of subcritical reactors; and (v) a control system for enabling such a tiered approach, which control system includes beam power control on an RF bucket basis for each subcritical reactor.

In one example of a design optimization for reliability, instead of fanning out power from one klystron to many RF cavities, it is contemplated that an individual power source may be used for each cavity. A power source failure may then be compensated by adjusting the synchronous phase of the other cavities within the linac, such that the protons may continue to be transported along the linac. It is contemplated that design optimization for reliability may also include the lessons learned from experimental accelerators, such as the SNS discussed above.

An accelerator section may be described by its design energy. In some applications, accelerator sections are described by, among other characteristics, an accelerated particle's speed with regard to the speed of light: The accelerator parameter β is a ratio of particle velocity divided by the speed of light, for a particular design of linac or linac section. For example, β may represent a measure of the performance of that linac in particle acceleration for that application. For the purposes of nomenclature, a “source” is intended to mean an ion or charged particle source, although it is contemplated that many or most embodiments may find a proton source to be appropriate. Thus, references to protons should not be construed as excluding embodiments for other particles as well. An accelerator section for a low design energy may sometimes be referred to as a “β<<1 section”, such as a radiofrequency quadrupole, a cyclotron, or a Cockroft-Walton device. A “β<1 linac section” would then correspond to a lower energy linear accelerator (i.e., with respect to a β=1 linac section) in which it is desirable for the embodiment to design extrinsic or numerical redundancy for reliability. A “β=1 linac section” generally corresponds to a higher energy linear accelerator, such as one in which particle speed may approach the speed of light (i.e., shown as β=1). Reference may also be made to relative values of design energy. For example, a first stage accelerator section may have a design energy lower than that of a main accelerator section. Some embodiments may include an identifiable second stage accelerator section, in which the second stage design energy may be greater than that of the first stage accelerator section, but lower than that of the main accelerator section. In this case, the at least one output of the first stage accelerator section is applied to the input of the main accelerator section via the second stage accelerator section. Thus, primary reference herein is to relative design energy for accelerator sections (and particle speeds) that are cost effective for a particular overall design and application.

An aspect of the present approach is to create most of the beam power with higher-gradient, efficient SRF cavities operating where the output particle velocity is close to the speed of light, such that capital and operating costs are reduced, as described herein.

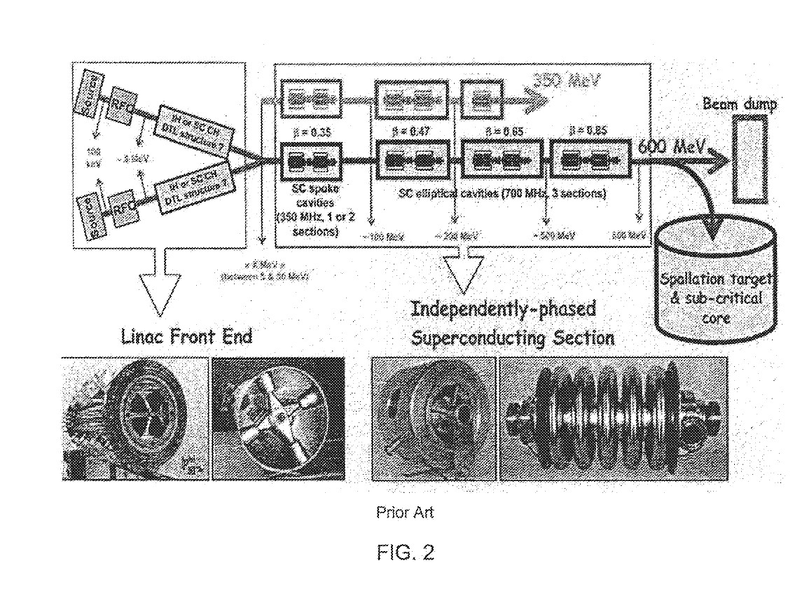

For applications that require acceleration of a particle to speeds approaching that of the speed of light, conventional approaches to accelerator design suggested a combination of linac sections positioned in simple series, such as the Project X design discussed herein or the Integrated Project on European Transmutation as shown in FIG. 2. The physical requirements for a linac section, such as the number of RF cavities per cryomodule, the cryomodule dimensions, or cryomodule period length, vary depending on the acceleration level and desired efficiency. The requirements for accelerating particles for low design energy sections are different from those for high design energy sections accelerating particles.

As a design principle for the present approach, low design energy accelerator sections are generally considered to be somewhat less reliable than higher design energy sections. In addition, the early stage sections are more challenging than the subsequent sections. For example, in the first stage section, for example there is less gradient, lower frequency, lower efficiency, a greater number of parts, all of which contribute to a more complex structure having greater expense and lower reliability. With subsequent sections at high design energy, the addition of beam power is easier to achieve.

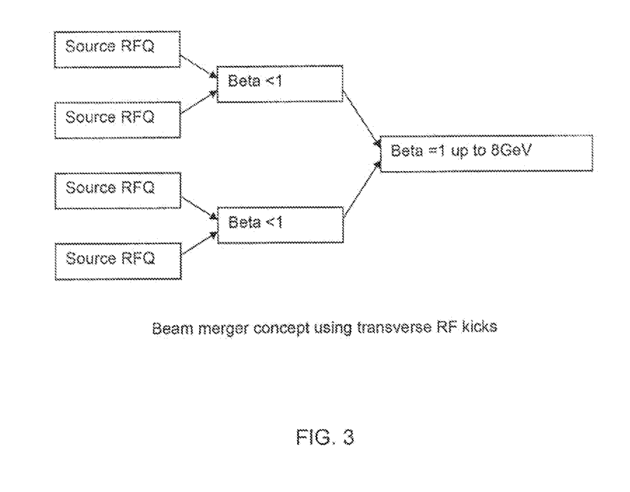

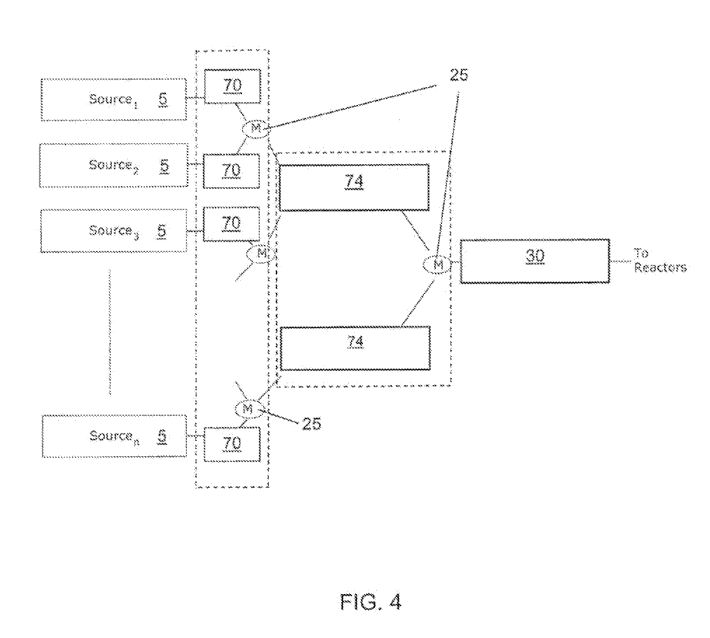

This lower level of reliability contributes to greater maintenance down time in conventional approaches. Accordingly, an aspect of embodiments of this approach is to arrange lower design energy sections in parallel instead of series. A sample embodiment of a conceptual picture operating up to 8 GeV is shown in FIG. 3. However, a more generic arrangement is illustrated in FIG. 4. In this arrangement, a plurality of sources, such as proton sources, may each be coupled to a low energy or first stage accelerator section [70]. These may then feed into a second stage accelerator section [74]. In turn, a plurality of these second stage sections [74] may ultimately be directed into a higher energy or later stage main accelerator section [30], via a merging device [25], on an RF bucket basis. A variety of tiers and configurations may be employed, such that the two step embodiment illustrated should be considered as an example; an application or design may make a three or more step arrangement desirable. A parallel arrangement of sources [5] may thus be accomplished if the particle beam paths can be merged into a single path, with one merger at the input to a main accelerator section [30].

It should be noted that the plurality of sources [5] and low energy accelerator sections [70] promote reliability by redundancy. For example, with reference to the embodiment of FIG. 4, in the event of a loss of one source [5] or low energy accelerator section [70], then other sources [5] and low energy accelerator sections [70] and/or second stage accelerator sections [74] may still be used to supply the downstream higher design energy main accelerator section [30]. Similarly, a loss of “Source₂” [5], for example, would not disable the illustrated second stage accelerator section [74].

It is contemplated that sources and other components preferably are controlled on a subcritical reactor basis, so as to achieve a desired subcritical reactor condition and/or output. Such control is also desired on a bunch by bunch basis through RF bucket control, as discussed further below. Control may be achieved by the use of devices such as beam dumps, choppers, etc. In addition, sensors and diagnostic devices may be interposed at control points as appropriate.

It is contemplated that merging device [25] may apply a transverse force or kick onto the beam. Multiple or redundant lower design energy sections [70, 74] may thus inject into the more robust, inherently redundant high energy main accelerator section [30]. The main accelerator section [30] may be a linear accelerator, such as a SRF LINAC. Alternatively, the main accelerator section [30] may have a plurality of RF cavities and a plurality of bending magnets configured for recirculation of particles between the RF cavities. The transverse force may be generated by any of a variety of approaches, such as transverse RF kicker or diverter, or by a steering magnet. In addition, with a plurality of Sources [5] and first stage accelerator sections [70], the beam hole radius should be sufficiently large to enable such merging.

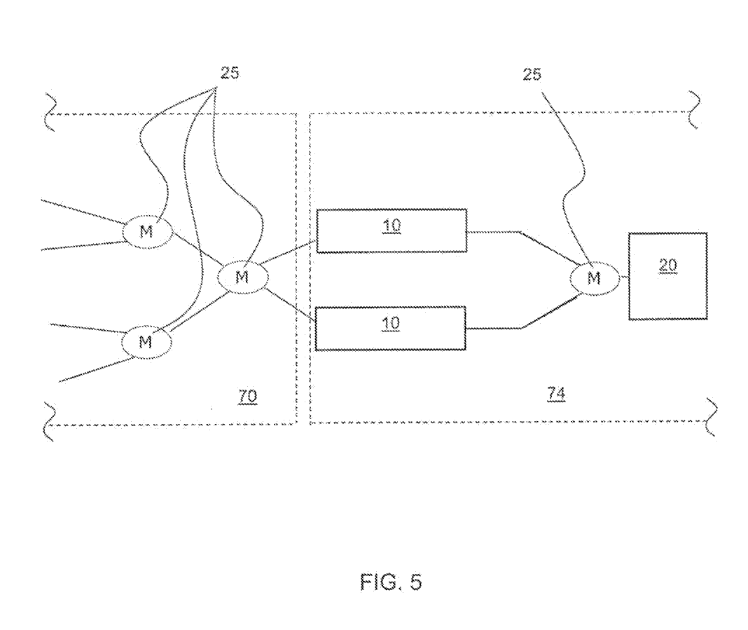

Depending on the application, the number of Sources [5] with first stage accelerator sections [70], and the number of tiers of early second stage accelerator sections [74], it may be desirable to incorporate sufficient merging capability so that redundancy is available even in the supply to second stage accelerator sections [74]. An embodiment with such tiered merging for second stage accelerator sections [74] is illustrated in FIG. 5.

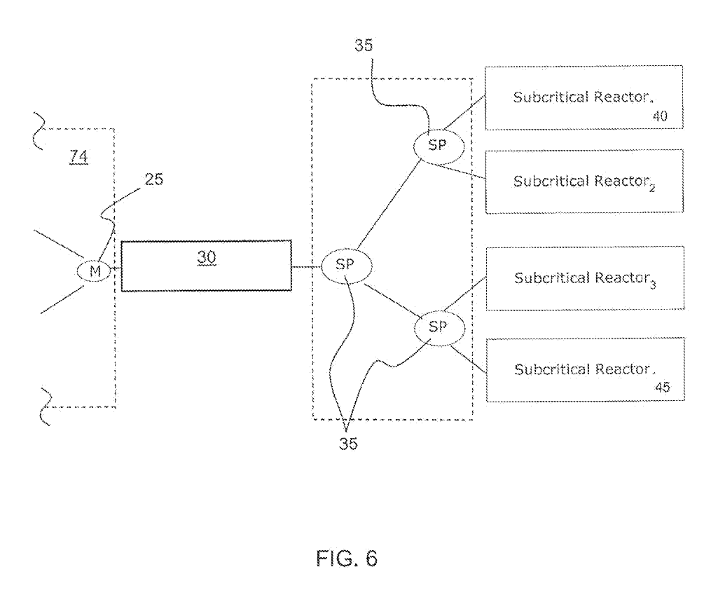

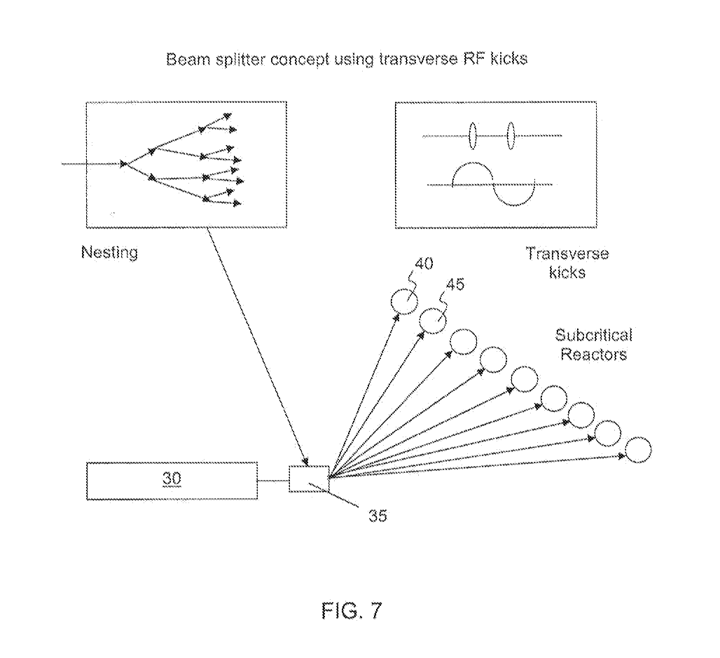

After acceleration of particles by the high energy, main accelerator section [30], it is desirable to supply multiple subcritical reactors [40, 45]. An embodiment of how this might be arranged is provided in FIG. 6. Splitting devices [35] may be provided in the form of a transverse RF beam splitter, kicker, or diverter. Splitting device [35] may be considered a reverse or output equivalent to input merging device [25]. FIG. 7 illustrates the operation of a splitting device [35]. From the main accelerator [30] the charged particle RF bunches are nested within the splitting device [35] and then split, for example, by transverse RF kicks. It should be noted that both merging device [25] and splitting device [35] could be constructed for more than two-way merging/splitting, as may be desired for the embodiment. The charged particle RF bunches are then distributed to the subcritical reactors [40, 45] as desired. A tiered arrangement of subcritical reactors [40, 45] where the reactive fertile nuclear material may be Th-232 or another known reactive fertile nuclear material enables increased power generation for the accelerator driven apparatus [1], as well as redundancy in the power generation portion. Subcritical reactors [40, 45] may be used for waste treatment or power generation; in the latter case, subcritical reactors [40, 45] may further have systems associated with power generation (not shown), such as a primary system containing a moderating primary medium, a secondary system containing a secondary medium, a heat transfer system for transferring thermal energy from the primary medium to the secondary medium, and a generating system for generating electric power from thermal energy in the secondary medium. In some cases, the subcritical reactors [40, 45] may have a spallation target of lead-beryllium or other known spallation target, such as uranium.

### Simplified Embodiment

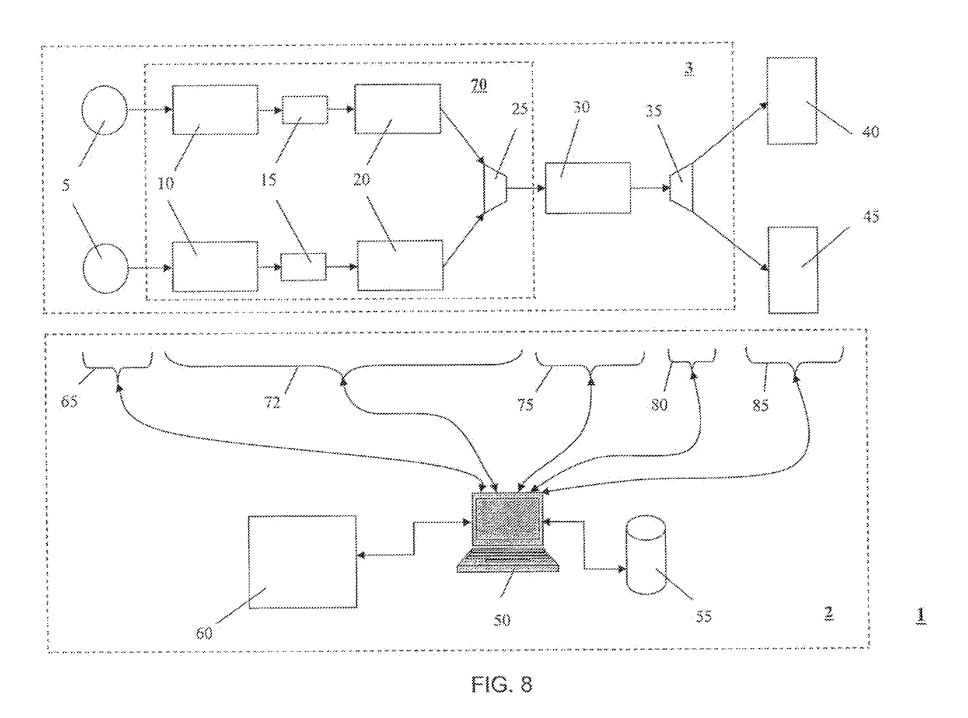

The above may be illustrated in a simplified embodiment of the apparatus for generating fission from fertile nuclear materials. FIG. 8 is a block diagram of this illustrative embodiment of an accelerator driven system or apparatus [1], including control system [2]. For clarity, two parallel front end systems are shown to aid in describing the function. At least two proton or other desired charged particle sources [5] are shown, which may, for example, be an electro-magnetic device used to generate charged particles. The source [5] output is directed by a source control [65]. As noted above, the charged particles may be protons or other charged particles. The output from source [5] is applied to an input for a low energy beam transport system (or LEBT) [10]. As shown in FIG. 8, the LEBT [10] is to the left of the radiofrequency quadrupole (or RFQ) [15] and a high energy beam transport system (or HEBT) [20]. For convention, a beam transport to the left of another will be illustrated as being at a lower energy than the beam transport to the right. This will become apparent should there be more than two accelerator sections or beam transports within a section. That is, within an accelerator section, the terms “LEBT [10]” and “HEBT [20]” denote a relative energy and disposition within the section, schematically. The apparatus [1] first stage accelerator section [70] includes an RFQ [15] for acceleration of the CW beam of charged particles. The RFQ [15] is shown associated with a single LEBT [10], but embodiments may have it associated with two LEBT [10], each with an output through an optional additional merging device (not shown). The RFQ [15] has at least one output, and is operably disposed between a desired number of LEBT [10] and at least one HEBT [20]. As shown the HEBT [20] output is applied to a merging device [25].

The at least one HEBT [20] may thus optionally be two or more HEBT [20], depending on the application. Output of HEBT [20] ultimately is applied to the next or second accelerator section [74]; in the case of multiple HEBT [20] of first stage accelerator section [70] shown, it is applied to merging device [25]. LEBT [10] discharges their output into the HEBT [20] via RFQ [15], and then to merging device [25], and so on.

The first stage accelerator section [70] thus comprises at least two LEBT [10] defining at least two inputs, at least one RFQ [15], at least one HEBT [20], and at least one merging device [25]. This first stage accelerator section [70] has a first stage design energy. Charged particles may be applied to each of the inputs of the LEBT [10] in the first stage accelerator section [70] in which the charged particles are bunched into radiofrequency (RF) buckets (not shown) and accelerated up to a design energy. At least one output of the first stage accelerator section [70] is directed to the input of the main accelerator section [30]. Each of these components may be individually controlled on an RF bucket basis, and are operably disposed between the out least one output and at least two inputs of the first stage accelerator section [70]. Operably disposed means that such components inter-relate functionally in a manner known in the art, to accelerate charged particles for the particular application.

A transverse kicking RF cavity or system, which is sometimes referred to as a “crab cavity” is an example of a merging device [25], and it may receive bunched inputs from a combination of items, such as a source [5], a chopping or bunching device (not shown), or from one or more LEBT [10] or HEBT [20]. The merging device [25] may be distributed, with cavities located within an LEBT [10] or an HEBT [20], but is shown separate in FIG. 8 for, clarity. Merging device [25] does not funnel or combine RF buckets, but instead directs RF buckets into a merged beam path.

As discussed above, the system may include a second stage accelerator section [74] (shown in FIG. 4) similar to first stage accelerator section [70], where at least one output of the first stage accelerator section [70] is applied to the input of the main accelerator section [30] via the second stage accelerator section [74].

Main accelerator section [30] includes an input and an output, wherein the main accelerator section [30] has a design energy that is greater than the design energy of the first stage accelerator section [70]. Main accelerator section [30] is shown singly to communicate the greater reliability of high energy accelerator sections. In embodiments having a second stage accelerator section [74]—(FIG. 4), the design energy of the second stage accelerator section [74] is generally greater than that of the first stage accelerator section [70], but less than that of the main accelerator section [30]. Even so, main accelerator section [30] may have component subsystems that are themselves composed of parallel paths and alternative trajectories for improved reliability through redundancy.

A splitting device [35], having an input and a plurality of outputs, is disposed such that the output of the main accelerator section [30] is applied to the input of the splitting device [35]. Thus, the output of RF buckets from the main accelerator section [30] is applied to the input of the splitting device [35]. The output of the splitting device [35] feeds into (or, in other words, these RF buckets are received by) at least two subcritical reactors [40, 45]. Splitting device [35] will be individually controlled such that the desired RF buckets from each source will be directed to a desired subcritical reactor [40] or [45]. Each subcritical reactor [40, 45] contains a fertile nuclear material (not shown). Each of the subcritical reactors [40, 45] are thus able to be controlled so as to generating fission within the fertile nuclear material at a desired reactor power based on that reactor's reception of a desired number of RF buckets having predetermined characteristics.

The apparatus [1] includes a control system [2] with a computer processor [50], a memory [55], a master oscillator [60] and a distribution system in operable communication with sources [5] (via source control [65]), the first stage accelerator section [70] (via first stage accelerator section control [72]), the main accelerator section [30] (via main accelerator section control [75]), the splitting device [35] (via splitting device control [80]), and the subcritical reactors [40, 45] (via subcritical reactor control [85]). When activated, the control system [2] assigns each RF bucket an identifier associated with a desired subcritical reactor [40, 45] and predetermined characteristics for such RF bucket. The computer processor [50] may access first operational requirement data for the radiofrequency accelerator associated with the first subcritical reactor [40] stored within the memory [55], second operational requirement data for the radiofrequency accelerator associated with the second subcritical reactor [45] stored within the memory [55] and a service software executable on processor [50].

In operation, a user may input instructions for a desired state of the apparatus [1] by interface with service software of control system [2]. The control system [2] may thus monitor and independently control the operation of the sources [5], the first stage accelerator section [70], the main accelerator section [30], and the splitting device [35]. This control is to enable, and produce for delivery to a desired subcritical reactor [40, 45], a desired number of RF buckets of such predetermined characteristics that upon delivery to the desired subcritical reactor [40, 45] the desired reactor power is generated.

The service software in communication with memory [55] is thus adapted to receive input instructions for a desired state of electrical power generation for the first and second subcritical reactors [40, 45]. The service software associates the input instructions with operational requirement data for the sources [5], first stage accelerator section [70], second (and any subsequent) stage accelerator section [74], main accelerator section [30], and splitting devices [35] making up the RF accelerator system [3] and communicates output instructions to the RF accelerator system [3] to produce the desired power level for the first and second subcritical reactors [40, 45]. The service software also associates the input instructions on an RF bucket basis using an assigned identifier.

The desired state may be associated with a number of RF cycles controlled by master oscillator [60] and computer [50] for the power to be generated by each subcritical reactor [40, 45]. Memory [55] may store operational requirement data associated with one or more subcritical reactors [40, 45], operational requirement data associated with one or more sources [5], and operational requirement data associated with the accelerator components. Computer [50] thus controls delays or time intervals relative to the master oscillator [60], to synchronize all RF devices in the accelerator system [3] such as RFQs [15] to a master reset signal. RF buckets may then be assigned identifiers based on a number of RF cycles from the master reset (e.g. 1, 2, 3, 4, . . . ). By interface, a user may choose which RF buckets of such predetermined characteristics that, upon delivery to a desired subcritical reactor [40, 45] will produce a desired power level. For example, in some cases, every even cycle may go to subcritical reactor [40] and every odd cycle to subcritical reactor [45]. The control system [2] may set the parameters by which sources [5] and the accelerator components uniquely supply each of subcritical reactors [40, 45]. LEBT [10], RFQ [15], and HEBT [20] may vary the energy level or other characteristics of RF buckets, for a desired final energy.

The power of each subcritical reactor [40, 45] may be adjusted by changing the current of its source [5], the number or frequency of cycles or RF bunches assigned to the specific subcritical reactor [40 or 45]. In its simplest form each source [5] may feed one subcritical reactor [40 or 45]; however it is desirable to be able to reassign sources [5] and first stage accelerator sections [70] as needed, which may assist in maintaining continuous operation in case of failure of an individual source [5] or other component. The control system [2] includes features for sensor feedback and safety for the entire system [1], inherent in the distribution system illustrated by the various controls [65, 72, 75, 80, 85].

A key aspect is that one main accelerator [30] can be used to feed several subcritical reactors [40, 45], with independent control of the high energy CW beam. By assigning identifiers and controlling RF bunch distribution (e.g., with direction via splitting device [35] and splitting device control [80]), calculated or desired RF bunches are delivered to the desired subcritical reactor [40, 45] to control the power. The final energy of the particle beam that is received by the subcritical reactors [40, 45] may be almost any desired energy level that may be optimal and cost effective. In this way, the control system [2] controls the operation of the RF accelerator [3] (i.e., sources [5], the first stage accelerator section [70], the main accelerator section [30], and the splitting device [35]) to produce for delivery to a desired subcritical reactor [40, 45] a desired number of RF buckets of such predetermined characteristics that upon delivery to the desired subcritical reactor [40 or 45], the desired reactor power is generated.

As noted, there may be a plurality of subcritical reactors [40, 45], and numerous sources [5], first stage accelerators sections [70], merging devices [25], etc., for a single main accelerator section [30]. This approach improves reliability and reduces cost. The first stage accelerator section [70] may be joined in parallel by other first stage accelerator sections [70], being supplied by multiple sources [5], and mirroring or multiplying the arrangement shown in FIG. 8 (or FIG. 4), or joined in series where each beam transport [10, 20] is adapted to a sequentially higher energy level prior to a merging device [25] or main accelerator section [30]. RFQs [15] may be discrete, or implemented as a distributed component of any beam transport [10, 20], and may be configured with more than one output.

Another aspect of embodiments of this approach is a fail safe computer based control system [2]. Such a control system [2] may comprise one or more computer processors [50] coupled with memory [55] for storing operational requirement data associated with one or more subcritical reactors [40, 45], operational requirement data associated with one or more sources [5], and operational requirement data associated with the remaining accelerator components discussed above. The control system [2] is in operable communication with the RF accelerator [3] components (including merging devices [25] and splitting devices [35]), the sources [5], and the subcritical reactors [40, 45] via a distribution system illustrated with the various controls [65, 72, 75, 80, 85]. The processor [50] may thus be adapted to receive instructions regarding selection and control or operation of one or more sources [5], for one or more subcritical reactors [40, 45], and a desired energy output. The processor [50] may execute service software that can be configured to optimize the operation efficiency of the apparatus [1] for the desired energy output, including a fail safe shutdown.

As noted above, the processor may be in communication with one or more merging devices [25] responsive to merging signals generated by the service software to send RF buckets from different sources [5] to a single subcritical reactor [40] or [45]. The processor [50] may be in communication with one or more splitting devices [35] responsive to splitting signals generated by the service software, routing RF buckets of predetermined characteristics to the appropriate subcritical reactor [40] or [45], or even a beam dump. The control system [2] may control the intensity and power of the sources [5], for example, permitting changing sources [5] without the need for interrupting the operation of the overall system. In some embodiments, it may be desirable to tailor the intensity and power of a source [5] for a particular subcritical reactor [40] or [45] on an RF bucket and bunch basis. Embodiments are contemplated also to control of a single source [5] for delivery to multiple subcritical reactors [40, 45], or multiple sources [5] for delivery to a single subcritical reactor [40] or [45] (even if multiple subcritical reactors are installed in parallel).

The present approach includes a development of accelerator-driven subcritical (ADS) nuclear power stations capable of producing on the order of ten or more GW of electrical power in an inherently safe region below criticality, generating no greenhouse gases, producing minimal nuclear waste and no byproducts that might be useful to rogue nations or terrorists, as well as processing of waste from conventional nuclear reactors. One fuel for ADS is commonly abundant thorium fuel that does not need enrichment. Of course, a primary benefit is the generation of reliable power and the transmutation of nuclear waste. However, applications of this approach may extend into other fields that could benefit from such accelerator configuration. For example, it is contemplated that the accelerator configurations disclosed herein may include application for environmental purification, including cleaning water, (e.g. destruction of pharmaceutical byproducts in drinking water), cleaning or destruction of flue gases, isotope production, including for medical uses, and the detection of special nuclear material using muon interrogation, for example.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention.

What is claimed is:

1. An apparatus for generating fission from fertile nuclear materials, the apparatus comprising:
(i) a radiofrequency accelerator for generating a continuous wave beam of charged particles, the accelerator comprising:
at least two sources, each having an output,
at least one first stage accelerator section comprising at least two inputs, at least one output, and operably disposed therebetween at least two LEBT systems, at least one HEBT system, at least one radio-frequency quadrupole, and at least one merging device, wherein the first stage accelerator section has a first stage design energy,
a main accelerator section with, an input and an output, wherein the main accelerator section has a design energy that is greater than the design energy of the first stage accelerator section,
wherein the output of a source is applied to each of the inputs of the first stage accelerator section, which bunches the particles into RF buckets, and the at least one output of the first stage accelerator section is applied to the input of the main accelerator section;
(ii) a splitting device having an input and a plurality of outputs, wherein the output of the main accelerator section is applied to the input of the splitting device;
(iii) at least two subcritical reactors, each subcritical reactor comprising a fertile nuclear material, each of the reactors positioned at an output of the splitting device so as to receive RF buckets and to generate fission within the fertile nuclear material at a desired reactor power;
(iv) a control system having a master oscillator and a distribution system in operable communication with the sources, the first stage accelerator section, the merging device, the main accelerator section, the splitting device, and the subcritical reactors; and
(v) wherein the control system, when activated, assigns each RF bucket an identifier associated with a desired subcritical reactor and predetermined characteristics for such RF bucket, the control system controlling the operation of the sources, the first stage accelerator section, the main accelerator section, and the splitting device, to produce for delivery to a desired subcritical reactor a desired number of RF buckets of such predetermined characteristics that upon delivery to the desired subcritical reactor, generate the desired reactor power.

2. The apparatus of claim 1, wherein the at least one merging device and the at least one radio-frequency quadrupole are disposed between the at least two LEBT systems and the at least one HEBT system.

3. The apparatus of claim 1, wherein the at least one merging device comprises at least two merging devices and at least one of the merging devices is disposed within one of the at least two LEBT systems.

4. The apparatus of claim 1, wherein the at least one merging device is disposed within the at least one HEBT system.

5. The apparatus of claim 1, wherein the at least one HEBT systems comprises at least two HEBT systems, the at least two LEBT systems discharge into the at least two HEBT systems, and the at least two HEBT systems discharge into the at least one merging device.

6. The apparatus of claim 1, wherein the radiofrequency accelerator further comprises at least one second stage accelerator section comprising at least one input, at least one output, and operably disposed therebetween at least one LEBT system, at least one HEBT system, at least one radio-frequency quadrupole, and wherein the second stage accelerator section has a second stage design energy that is greater than the first stage design energy and less than the main stage design energy, and the at least one output of the first stage accelerator section is applied to the input of the main accelerator section via the second stage accelerator section.

7. The apparatus of claim 6, wherein the at least one merging device is disposed between the at least one HEBT system of the first stage accelerator section and the at least one LEBT system of the second stage accelerator section.

8. The apparatus of claim 1, wherein the main accelerator section is a linear accelerator.

9. The apparatus of claim 8, wherein the linear accelerator is a superconducting linear accelerator.

10. The apparatus of claim 8, wherein the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium.

11. The apparatus of claim 1, wherein the at least two subcritical reactors further comprise a spallation target having lead-beryllium or uranium.

12. The apparatus of claim 1, wherein the splitting device is a transverse radiofrequency beam splitter.

13. The apparatus of claim 1, wherein the at least one merging device is a transverse kicking radiofrequency cavity.

14. The apparatus of claim 1, wherein the fertile nuclear material is Th-232.

15. The apparatus of claim 1, wherein the main accelerator section comprises a plurality of RF cavities and a plurality of bending magnets configured for recirculation of particles between the RF cavities.

16. The apparatus of claim 15, wherein the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium.

17. The apparatus of claim 1, further comprising:
wherein the at least two subcritical reactors comprise a first and a second subcritical reactor;
the control system further comprises a computer processor and a memory, first operational requirement data for the radiofrequency accelerator associated with the first subcritical reactor stored within the memory, second operational requirement data for the radiofrequency accelerator associated with the second subcritical reactor stored within the memory, a service software executable on the processor, the service software in communication with memory; and
wherein the service software is adapted to receive input instructions for a desired state of electrical power generation for the first and second subcritical reactors, associate the input instructions with operational requirement data for the radiofrequency accelerator, and to communicate output instructions to the radiofrequency accelerator to produce the desired power level for the first and second subcritical reactors.

18. The apparatus of claim 17, wherein the service software associates the input instructions with operational requirement data on an RF bucket basis.

19. The apparatus of claim 18, wherein the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium.

20. The apparatus of claim 18, wherein:
the at least one merging device is a transverse kicking radiofrequency cavity;
the splitting device is a transverse radiofrequency beam splitter;
the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium.

21. The apparatus of claim 17, wherein:
the service software associates the input instructions with operational requirement data on an RF bucket basis;
the at least one merging device is a transverse kicking radiofrequency cavity;
the splitting device is a transverse kicking radiofrequency cavity;
the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium.

22. The apparatus of claim 17, wherein:
the service software associates the input instructions with operational requirement data on an RF bucket basis using the assigned identifier;
the at least one merging device is a transverse kicking radiofrequency cavity;
the splitting device is a transverse kicking radiofrequency cavity;
the at least two subcritical reactors further comprise a primary system containing a moderating primary medium, a secondary system containing a secondary medium, a heat transfer system for transferring thermal energy from the primary medium to the secondary medium, and a generating system for generating electric power from thermal energy in the secondary medium; and
the control system is adapted to direct a desired RF bucket to a desired subcritical reactor.

23. An apparatus for generating fission from Th-232, the apparatus comprising:
(i) a radiofrequency accelerator for generating a continuous wave beam of charged particles, the accelerator comprising:
at least two sources, each having an output,
at least one first stage accelerator section comprising at least two inputs, at least one output, and operably disposed therebetween at least two LEBT systems, at least one HEBT system, at least one radio-frequency quadrupole, and at least one merging device, wherein the first stage accelerator section has a first stage design energy and the at least one merging device is a transverse kicking radiofrequency cavity,
a main accelerator section with an input and an output, wherein the main accelerator section has a design energy that is greater than the design energy of the first stage accelerator section,
wherein the output of a source is applied to each of the inputs of the first stage accelerator section, which bunches the particles into RF buckets, and the at least one output of the first stage accelerator section is applied to the input of the main accelerator section;
(ii) a splitting device having an input and a plurality of outputs, wherein the output of the main accelerator section is applied to the input of the splitting device, and wherein the splitting device is a transverse radiofrequency beam splitter;
(iii) at least two subcritical reactors comprising a first and a second subcritical reactor, each subcritical reactor comprising Th-232, each of the reactors positioned at an output of the splitting device so as to receive RF buckets and to generate fission within the Th-232 at a desired reactor power, and wherein the at least two subcritical reactors further comprise a spallation target having lead-beryllium;
(iv) a control system having a master oscillator and a distribution system in operable communication with the sources, the first stage accelerator section, the main accelerator section, the splitting device, and the subcritical reactors;
(v) wherein the control system, when activated, assigns each RF bucket an identifier associated with a desired subcritical reactor and predetermined characteristics for such RF bucket, the control system controlling the operation of the sources, the first stage accelerator section, the main accelerator section, and the splitting device, to produce for delivery to a desired subcritical reactor a desired number of RF buckets of such predetermined characteristics that upon delivery to the desired subcritical reactor, generate the desired reactor power;
(vi) the control system further comprises a computer processor and a memory, first operational requirement data for the radiofrequency accelerator associated with the first subcritical reactor stored within the memory, second operational requirement data for the radiofrequency accelerator associated with the second subcritical reactor stored within the memory, a service software executable on the processor, the service software in communication with memory; and
(vii) wherein the service software is adapted to receive input instructions for a desired state of electrical power generation for the first and second subcritical reactors, to associate the input instructions with operational requirement data for the radiofrequency accelerator, and to communicate output instructions to the radiofrequency accelerator to produce the desired power level for the first and second subcritical reactors.
